(19) United States
(12) Patent Application Publication
(10) Pub. No.: US 2024/0345873 A1
(43) Pub. Date: Oct. 17, 2024

(54) CONTROLLING AGENTS BY SWITCHING BETWEEN CONTROL POLICIES DURING TASK EPISODES

(71) Applicant: DeepMind Technologies Limited, London (GB)

(72) Inventors: Tom Schaul, London (GB); Miruna Pîslar, Paris (FR)

(21) Appl. No.: 18/294,784

(22) PCT Filed: Aug. 3, 2022
(86) PCT No.: PCT/EP2022/071864

§ 371 Date: Feb. 2, 2024

Related U.S. Application Data
(60) Provisional application No. 63/229,050, filed on Aug. 3, 2021.

(51) Int. Cl. G06F 9/48

(52) U.S. Cl. CPC G06F 9/4875

(57) ABSTRACT

Methods, systems, and apparatus, including computer programs encoded on a computer storage medium, for controlling agents. In particular, an agent can be controlled to perform a task episode by switching the control policy that is used to control the agent at one or more time steps during the task episode.

### BACKGROUND

Tis specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that controls an agent interacting with an environment to attempt to perform a task in the environment. While controlling the agent during an episode in which the agent attempts to perform an instance of the task, the system can switch between multiple different control policies. For example, during the task episode, the system can switch between controlling the agent using an exploratory control policy and an exploitative control policy using an “intra-episode” switching scheme.

The claims below make reference to “first,” “second,” and “third” control policies. It should be understood that these terms are only used for ease of readability and do not imply any order between the control policies. Moreover, the use of “first,” “second,” and “third” does not imply that the set of control policies has to include all three of the control policies that are referred. In fact, the set of control policies can include none of the first, second, or third policies, only the first policy, only the second policy, only the third policy, or any combination of two or more of the first, second, and third policies.

In one aspect, one of the methods includes maintaining control policy data for controlling an agent to interact with an environment, the control policy data specifying: (i) a plurality of control policies for controlling the agent, (ii) for each of the control policies, a respective switching criterion that governs switching, during a task episode, from controlling the agent using the control policy to controlling the agent using another control policy from the plurality of control policies; and controlling the agent to perform a task episode in the environment, wherein, during the task episode, the agent performs a respective action at each of a plurality of time steps that is selected using a respective one of the plurality of control policies, and wherein controlling the agent to perform the task episode comprises, at each of the plurality of time steps receiving a current observation characterizing a state of the environment at the time step; identifying a control policy that was used to select the action that was performed by the agent at a preceding time step; determining whether the respective switching criterion for the identified control policy is satisfied at the current time step; selecting a control policy from the plurality of control policies based on whether the respective switching criterion for the identified control policy is satisfied at the current time step; selecting an action to be performed by the agent in response to the current observation using the selected control policy; and causing the agent to perform the selected action. Thus, the system can adaptively switch between control policies with an “intra-episode” granularity.

In some implementations the plurality of control policies comprise: an exploration control policy that selects actions to cause the agent to attempt to explore the environment; and an exploitation control policy that selects actions to cause the agent to attempt to successfully perform a task in the environment during the task episode. Thus, the system can adaptively switch between exploring and exploiting the environment with an “intra-episode” granularity.

In some implementations the exploration control policy is a random control policy that selects an action from a set of possible actions uniformly at random.

In some implementations the exploration control policy selects an action from a set of possible actions that optimizes a novelty measure as estimated by the exploration control policy.

In some implementations the exploitation control policy is learned through reinforcement learning and selects actions that cause the agent to maximize an expected future return as estimated by the exploitation control policy.

In some implementations, the method further comprises: generating, from at least the observations received at the plurality of time steps and the actions performed at the plurality of time steps, training data; and updating one or more of the control policies using the training data.

In some implementations, for a first control policy of the plurality of control policies, the respective switching criterion specifies that the agent switches from being controlled by the first control policy after the agent has been controlled by the control policy for a threshold number of time steps during the task episode.

In some implementations the threshold number is selected from a set of possible threshold numbers using a non-stationary multi-armed bandit that maximises episodic return. Thus, the system can adaptively select the threshold to maximize the quality of the data generated as a result of the interaction.

In some implementations, for a second control policy of the plurality of control policies, the respective switching criterion specifies that the agent switches from being controlled by the second control policy with a specified probability after each time step at which the second control policy is used to control the agent.

In some implementations the specified probability is selected from a set of possible probabilities using a non-stationary multi-armed bandit that maximises episodic return. Thus, the system can adaptively select the probability to maximize the quality of the data generated as a result of the interaction.

In some implementations, for a third control policy of the plurality of control policies, the respective switching criterion specifies that the agent switches from being controlled by the third control policy at a given time step based on a trigger value for the given time step. As described below, using the trigger value allows the system to perform “informed” rather than “blind” switching.

In some implementations, when the identified control policy is the third control policy, determining whether the respective switching criterion for the identified control policy is satisfied at the current time step comprises: computing a trigger value for the current time step based on a state of the task episode as of the current time step; and determining whether the respective switching criterion for the third control policy is satisfied based on the trigger value for the current time step.

In some implementations, the trigger value for the current time step is an estimate of an uncertainty in reward estimates generated by the third control policy over a recent time window as of the current time step.

In some implementations, the trigger value measures an accuracy of an estimate, generated by the third control policy, of a value of the environment being in an earlier state at an earlier time step in the recent time window given actual rewards that have been received at time steps after the earlier time step.

In some implementations, the third control policy comprises an ensemble of neural networks, and wherein the trigger value measures a discrepancy between outputs of the neural networks in the ensemble generated by processing inputs comprising the current observation.

In some implementations, wherein the third control policy comprises an ensemble of neural networks, and wherein the trigger value measures a variance between outputs of the neural networks in the ensemble generated by processing inputs comprising the current observation.

In some implementations, the trigger value for the current time step is an estimate of a saliency of stimuli observed by the agent as of the current time step.

In some implementations, the trigger value for the current time step is an estimate of a minimal coverage as of the current time step.

In some implementations, the trigger value for the current time step is an estimate of information-theoretic capacity of an actuation channel of the agent as of the current time step.

In some implementations the method further comprises: determining a specified threshold value for the current time step; and determining whether the respective switching criterion for the third control policy is satisfied based on a difference between the specified threshold value for the current time step and the trigger value for the current time step.

In some implementations, the specified threshold value is a same predetermined value for each of the time steps in the task episode, and wherein determining whether the respective switching criterion for the third control policy is satisfied based on a difference between the specified threshold value for the current time step comprises: determining that the criterion is satisfied when the trigger value exceeds the switching criterion; or determining whether the criterion is satisfied based on a value sampled from a probability distribution parameterized based on the difference between the specified threshold value for the current time step and the trigger value for the current time step.

In some implementations, determining whether the respective switching criterion for the third control policy is satisfied comprises: obtaining a target switching rate for the current time step; generating a standardized and exponentiated current trigger value for the current time step based on previous trigger values at preceding time steps within the task episode; and determining whether the respective switching criterion for the third control policy is satisfied based on the target switching rate for the current time step and the standardized and exponentiated current trigger value. Using the “target switching rate” can allow the system to perform switching based on “homeostasis,” as is described in more detail below.

In some implementations, determining whether the respective switching criterion for the third control policy is satisfied based on the target switching rate for the current time step and the standardized and exponentiated current trigger value comprises: mapping the target switching rate for the current time step and the standardized and exponentiated current trigger value to a parameter that defines a probability distribution; sampling a value from the probability distribution; and determining whether the respective switching criterion for the third control policy is satisfied based on the sampled value.

In some implementations, the target switching rate is a same predetermined value for each of the time steps in the task episode.

In some implementations, the target switching rate comprises: selecting the target switching rate from a set of possible target switching rates using a non-stationary multi-armed bandit that maximises episodic return. Thus, the system can adaptively select the target switching rate to maximize the quality of the data generated as a result of the interaction.

Particular embodiments of the subject matter described in this specification can be implemented so as to realize one or more of the following advantages.

Exploring an environment while generating training data for learning a control policy for controlling an agent is important to being able to learn a high-performing policy. However, how to effectively explore remains a central challenge for effective learning of a final control policy, particularly for complex tasks like those that require interacting with a real-world environment. That is, performing well on complex tasks after training requires that the training data represent both diverse aspects of the state of the environment and diverse means of completing the task. However, this is challenging at least in part because the structure of the state space and how to perform the task are not known at the outset of learning.

Many existing methods share the feature of a monolithic behaviour policy that controls the agent during training to generate the training data and that changes only gradually (at best). This single behavior policy can be the same policy that is being learned by the training system or a different, fixed policy. Some other methods switch between behavior policies only in between episodes.

This specification, on the other hand, describes techniques for switching between control policies “intra-episode”, e.g., switching between control policies at one or more time steps within a task episode. This intra-episode switching allows exploration to continue for multiple consecutive time steps without requiring the exploration to continue for an entire task episode. This type of exploration results in training data being generated that represents diverse aspects of the state space of the environment and allows a training system to learn a control policy that can effectively control an agent to consistently complete complex tasks, e.g., real-world interaction tasks.

Moreover, by maintaining respective switching criteria for each of the multiple policies, the system can attain a desirable trade-off between exploration and exploitation, ensuring that the training data both captures diverse states of the environment and includes examples of successfully completing all of or a portion of the task once in those states.

Compared to conventional systems, the system described in this specification may consume fewer computational resources (e.g., memory and computing power) by training the action selection neural network(s) to achieve an acceptable level of performance over fewer training iterations. Moreover, a set of one or more action selection neural networks trained by the system described in this specification can select actions that enable the agent to accomplish tasks more effectively (e.g., more quickly) than an action selection neural network trained by an alternative system because the agent achieves a better trade-off between different modes of behavior when generating training data for the action selection neural network.

In some implementations, the system implements, for one or more of the control policies, an “informed” switching criterion that switches based in part on a current state of the episode, e.g., the current state of the environment or current and/or previous outputs generated by the control policy. Using informed switching criteria can allow the system to only switch between control policies if the current state of the episode indicates that the switch would be beneficial to the learning of the final control policy. For example, switching based on a trigger value facilitates switching based on an uncertainty of the system about which action to take at a time step or about the estimated value of a present or past state of the environment or action, e.g. as determined by a value or action-value (Q) neural network used to control the agent. Such “informed switching” can facilitate deciding when system should switch from exploitation to exploration, e.g. switching to exploration when uncertainty is high.

In some implementations, the system makes use of a target switching rate, rather than an absolute threshold value, to determine when to switch using a trigger value for an informed criterion. While directly comparing the trigger value to a threshold value may be effective for certain tasks, for other tasks, the scales of the informed trigger signals may vary substantially from other tasks and across training time within training for the same task. This can make it difficult to select an effective threshold value at the outset of any given task episode, e.g., it is impractical to attempt to manually set the threshold hyper-parameter. Therefore, in some implementations, instead of directly comparing the trigger value to the threshold value, the system can use a target switching rate to ensure that policies switch at the rate that ensures that the highest-quality and most-useful training data is generated.

In some implementations, the system determines whether the switching criterion is satisfied using “homeostasis”. By making use of homeostasis, the system only requires specifying the target switching rate, which can be constant across domains but still function as an adaptive threshold, making tuning straightforward when the described techniques are applied for a new task because the target rate of switching is configured independently of the scales of the trigger signal. For example the threshold can be adapted with the aim of achieving the target switching rate, on average. This can eliminate the need for computationally expensive hyperparameter sweeps that are required by other techniques.

Moreover, in some implementations, the system updates one or more of the parameters for one or more of the switching criteria for one or more of the control policies using a non-stationary bandit that maximises episodic returns. Updating these parameters using the bandit allows the system to modify how the switching criteria are applied as training progresses, further improving the quality of the resulting training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example action selection system.

FIG. 2 is a diagram showing examples of switching schemes that switch between control policies.

FIG. 3 is a flow diagram of an example process for controlling an agent to perform a task episode.

FIG. 4 is a flow diagram of an example process for selecting a parameter value from a set of parameter values using a non-stationary multi-armed bandit.

FIG. 5 is a flow diagram of an example process for determining whether a switching criterion is satisfied at the current time step using a target switching rate.

FIG. 6 shows the performance of various intra-episode switching schemes relative to other control schemes.

Like reference numbers and designations in the various drawings indicate like elements.

### DETAILED DESCRIPTION

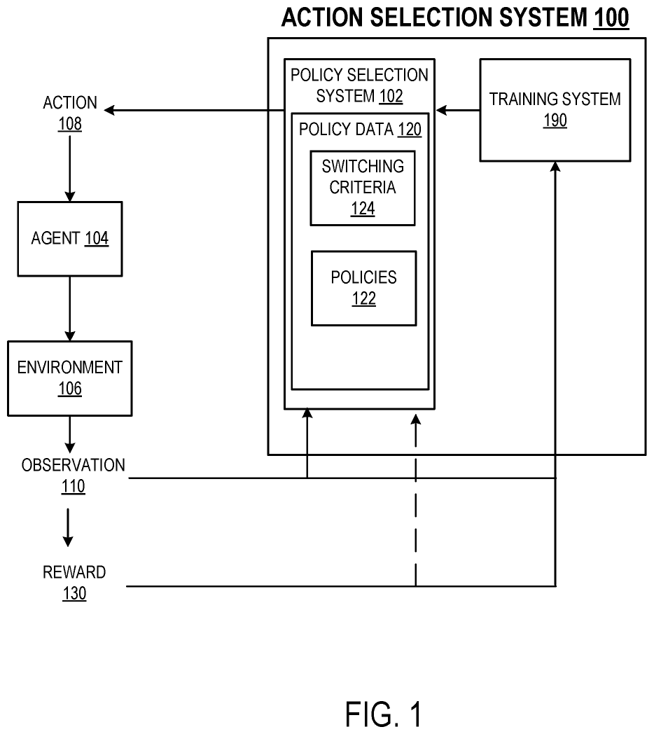

FIG. 1 shows an example action selection system 100. The action selection system 100 is an example of a system implemented as computer programs on one or more computers in one or more locations in which the systems, components, and techniques described below are implemented.

The action selection system 100 controls an agent 104 interacting with an environment 106 to accomplish a task by selecting actions 108 to be performed by the agent 104 at each of multiple time steps during the performance of an episode of the task.

As one general example, the agent can be a mechanical agent or a simulated mechanical agent and the task can include one or more of, e.g., navigating to a specified location in the environment, identifying a specific object in the environment, manipulating the specific object in a specified way, and so on.

As another general example, the agent can be an electronic agent configured to control operation of at least a portion of a service facility and the task can include controlling the facility to satisfy a specified objective.

As yet another general example, the agent can be an electronic agent configured to control a manufacturing unit or a machine for manufacturing a product and the task can include manufacturing a product to satisfy a specification.

More generally, the task is specified by received rewards, e.g., such that an episodic return is maximized when the task is successfully completed.

Rewards and episodic returns will be described in more detail below. These and other examples of agents, tasks, and environments are also described in more detail below.

An “episode” of a task is a sequence of interactions during which the agent attempts to perform a single instance of the task starting from some starting state of the environment. In other words, each task episode begins with the environment being in an initial state, e.g., a fixed initial state or a randomly selected initial state, and ends when the agent has successfully completed the task or when some termination criterion is satisfied, e.g., the environment enters a state that has been designated as a terminal state or the agent performs a threshold number of actions without successfully completing the task.

At each time step during any given task episode, the system 100 receives an observation 110 characterizing the current state of the environment 106 at the time step and, in response, selects an action 108 to be performed by the agent 104 at the time step. After the agent performs the action 108, the environment 106 transitions into a new state and the system 100 receives a reward 130 from the environment 106.

Generally, the reward 130 is a scalar numerical value and characterizes a progress of the agent 104 towards completing the task.

As a particular example, the reward 130 can be a sparse binary reward that is zero unless the task is successfully completed and one if the task is successfully completed as a result of the action performed.

As another particular example, the reward 130 can be a dense reward that measures a progress of the agent towards completing the task as of individual observations received during the episode of attempting to perform the task, e.g., so that non-zero rewards can be and frequently are received before the task is successfully completed.

A training system 190 uses the data collected as a result of the agent performing task episodes to train a neural network or other machine learning model that, after training, can be used to control the agent to perform the tasks. That is, the training system 190 generates, from at least the observations received at the plurality of time steps in the task episode, training data and trains the machine learning model using the training data. As a particular example, the system 190 can also use the rewards received at the time steps to train the machine learning through reinforcement learning (to perform the task).

In order for the training system 190 to effectively train the machine learning model, the system 100 needs to generate training data that accurately represents the possible states and scenarios that will be encountered by the agent 104 while performing instances of the task after learning. This requires a combination of “exploring” the environment 106, e.g., acting with the aim of discovering new states that are different from states previously encountered by the agent and “exploiting” the system's knowledge, e.g., acting with the aim of successfully completing the task starting from the current environment state, so that the training data includes instances of the task being successfully performed. For complex tasks like those that that require interacting with a real-world environment, the challenge for exploration becomes to keep producing diverse experience throughout the course of training, because if a situation has not been encountered, an appropriate response cannot be learned during the training.

Therefore, in order to control the agent 104 and to generate training data for use by the training system 190, the system 100 maintains control policy data 120.

The control policy data 120 specifies: (i) a plurality of control policies 122 for controlling the agent 108 and (ii) for each of the control policies 122, a respective switching criterion 124 that governs switching, during a task episode, from controlling the agent 104 using the control policy 122 to controlling the agent 104 using another control policy 122 from the plurality of control policies.

In other words, for each control policy 122 and during a given task episode, if the respective switching criterion for the control policy is satisfied while the agent 108 is being controlled using the control policy, the system 100 switches to controlling the agent 108 using another one of the control policies.

A “control policy” can be any function that generates an output that identifies an action to be performed by the agent 104. For some control policies, the action can be independent of the observation 110, e.g., does not depend on the current state of the environment, while, for some other control policies, the action can depend on the observation 110. As will be described in more detail below, in some implementations, one or more of the control policies make use of the machine learning model being trained by the training system 190 in order to map observations to actions.

More specifically, the multiple control policies encourage the agent 104 to perform varying amounts of exploration and, in some cases, different types of exploration from one another.

For example, the multiple control policies can be an exploration control policy that selects actions to cause the agent 104 primarily to attempt to explore the environment (rather than perform the task), and an exploitation control policy that selects actions to cause the agent 104 primarily to attempt to successfully perform the task in the environment during the task episode (rather than explore the environment), e.g., without regard for exploring the environment.

As another example, the multiple control policies can include the exploitation control policy and multiple different exploration control policies that select actions to cause the agent 104 to attempt to explore the environment in different ways, e.g., with different levels of optimism.

As another example, the multiple control policies can include the exploitation control policy, the exploration control policy, a novelty control policy, and a mastery control policy. Novelty and mastery control policies are described in more detail in A. L. Thomaz and C. Breazeal. Experiments in socially guided exploration: Lessons learned in building robots that learn with and without human teachers. Connection Science, 20(2-3):91-110, 2008.

Generally, at least one of the control policies is a “learned” policy that makes use of outputs generated by a machine learning model, e.g., a deep neural network. Thus, as described above, the training system 190 can use the data collected as a result of the agent 104 performing the task episode to update one or more of the control policies 122, e.g., by training the neural network used by one or more of the control policies 122 on training data that includes the collected data, e.g. using reinforcement learning, in particular based on rewards received at the time steps.

In particular, the deep neural network used by a given learned control policy can have any appropriate neural network architecture that enables it to perform its described functions, e.g., processing an input that includes an observation 110 of the current state of the environment 106 to generate an action selection output that characterizes an action to be performed by the agent 104 in response to the observation 110. For example, the deep neural network can include any appropriate number of layers (e.g., 5 layers, 10 layers, or 25 layers) of any appropriate type (e.g., fully connected layers, convolutional layers, attention layers, transformer layers, etc.) and connected in any appropriate configuration (e.g., as a linear sequence of layers).

In one example, the action selection output may include a respective numerical probability value for each action in a set of possible actions that can be performed by the agent. The system 100 can select the action to be performed by the agent 104 using this control policy by, e.g., sampling an action in accordance with the probability values for the actions, or by selecting the action with the highest probability value.

In another example, the action selection output may directly specify the action to be performed by the agent 104, e.g., by outputting the values of torques that should be applied to the joints of a robotic agent. The system 100 can then select the action to be performed by the agent 104 using this control policy by selecting the specified action.

In another example, the action selection output may include a respective Q-value for each action in the set of possible actions that can be performed by the agent 104. The system 100 can select the action to be performed by the agent 104 using this control policy by processing the Q-values (e.g., using a soft-max function) to generate a respective probability value for each possible action, which can be used to select the action to be performed by the agent 104 (as described earlier). The system 100 could also select the action with the highest Q-value as the action to be performed by the agent.

The Q value for an action is an estimate of a “return” that would result from the agent 104 performing the action in to the current observation and thereafter selecting future actions performed by the agent in accordance with current values of the policy neural network parameters.

A return refers to a cumulative measure of rewards 130 received by the agent 104, for example, a time-discounted sum of rewards or an undiscounted sum of rewards. As will be described in more detail below, an “episodic” return refers to a cumulative measure of rewards 130 received by the agent 104 across all of the time steps in an episode, for example, a time-discounted sum of rewards or an undiscounted sum of rewards.

Optionally, the action selection output can also include a value estimate for the current state characterized by the input observation that estimates the return that will be received starting from the current observation until the end of the task episode. That is, the value estimate is an estimate of the cumulative measure of rewards 130 that will be received by the agent 104 once the agent 104 performs some action in response to the input observation.

Some specific examples of control policies 122 that can be used by the system 100 will now be described. However, it should be understood that these are merely exemplary and that any of a variety of combinations of control policies 122 can be used by the system 100.

As described above, in some implementations, the multiple control policies are an exploration control policy and an exploitation control policy.

In some of these implementations, the exploration control policy is a random control policy. A random control policy is one that selects an action from the set of possible actions that can be performed by the agent uniformly at random.

In others of these implementations, the exploration control policy selects an action from the set of actions that optimizes a novelty measure as estimated by the exploration control policy, e.g., selects the action that the exploration control policy predicts will lead to the most “novel” portion of the state space of the environment when performed when the environment is in the current state as measured by the novelty measure. Thus the novelty measure may comprise a measure of the novelty of a region of the state space of the environment including the current state of the environment. A particular example of this type of control policy is one that, instead of selecting actions to maximize rewards 130 or returns computed from the rewards 130, selects actions to maximize the novelty measure for encountered states that measures how different a given state is from states that have been previously encountered by the agent. For example, this control policy can be one that attempts to maximize a novelty measure based on random network distillation (RND). This control policy is described in more detail in Yuri Burda, Harrison Edwards, Amos J. Storkey, and Oleg Klimov. Exploration by random network distillation. CoRR, abs/1810.12894, 2018, the entirety of which is hereby incorporated by reference herein.

In some implementations, the exploitation control policy is learned through reinforcement learning and selects actions that cause the agent to maximize an expected future return as estimated by the exploitation control policy. For example, the exploitation control policy can use the action selection neural network described above, and the action selection neural network can be one of the models that are being trained by the training system 190. That is, the training system 190 can train the neural network used by the exploitation control policy through an appropriate reinforcement learning technique so that exploitation control policy improves as more and more task episodes are collected.

As another example, both the exploitation control policy and the exploration control policy can make use of the above-described action selection neural network. For example, the exploration control policy and the exploitation control policy can both apply an ε-greedy policy in which the system 100 selects the action with the highest final return estimate according to the action selection output with probability 1−ε and selects a random action from the set of actions with probability ε. In this example, the exploration control policy can make use of a larger value of a than the exploitation control policy, e.g., so that the exploration control policy more frequently selects an explorative, randomly-selected action. For example, for the exploration control policy the value of ε can be 0.4 and for the exploitation control policy the value can be 0.1.

As another example, the exploitation control policy and the exploration control policy can each make use of a different action selection neural network. For example, the exploration control policy can make use of an action selection neural network that is being trained by the system 190 to optimize returns computed using a first value of a discount factor while the exploitation control policy can make use of an action selection neural network that is being trained by the system 190 to optimize returns computed using a second, lower value of the discount factor. In particular, the discount factor defines the degree to which temporally distant rewards are discounted when computing the return at a given time step. That is, the return starting from a time step t can be computed as:

Σᵢγ^{i-t-1}rᵢ,

where i ranges either over all of the time steps after t in the episode or for some fixed number of time steps after t within the episode, γ is the discount factor, and rᵢ is an overall reward at time step i. As can be seen from the above equation, higher values of the discount factor result in a longer time horizon for the return calculation, e.g., result in rewards from more temporally distant time steps from the time step t being given more weight in the return computation. Thus, by having the discount factor have a higher value, the exploration policy more strongly emphasizes potential longer-term rewards while the exploitation policy emphasizes immediate rewards.

When the control policies 122 include multiple different exploration policies, the multiple exploration policies can include any combination of any of the exploration policies described above.

As described above, each policy 122 has a corresponding switching criterion 124 that governs when to switch away from using the policy 122 for controlling the agent 104 during a task episode. Different policies 122 can have different switching criteria 124, e.g., the criterion for switching away from one policy 122 can be different than the criterion for switching away from another policy.

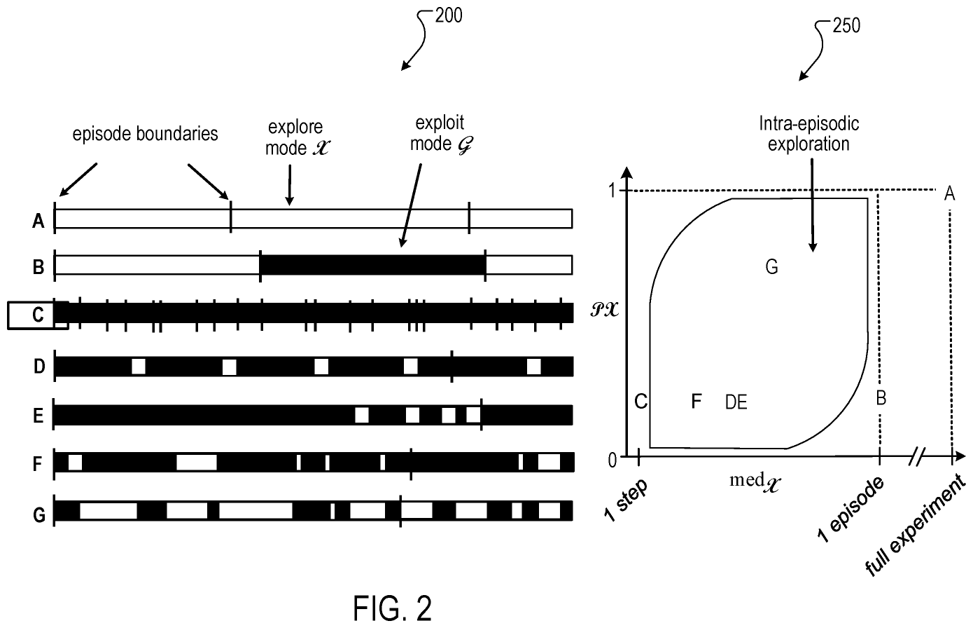

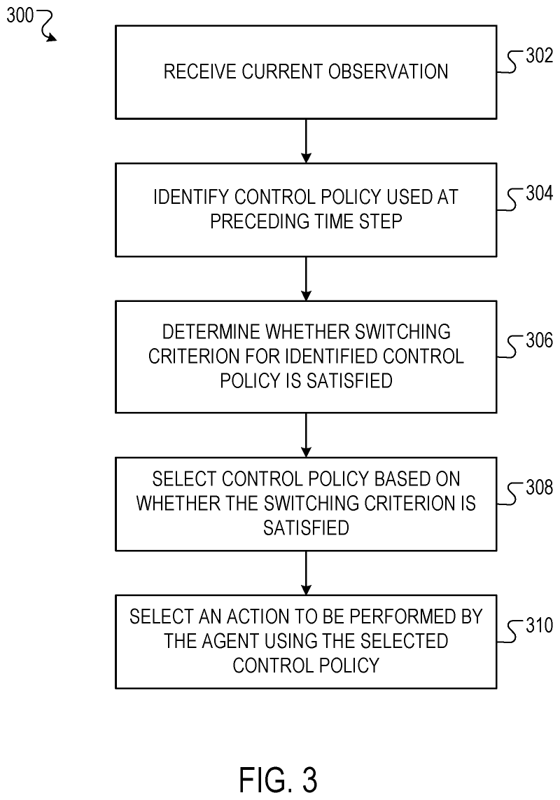

Examples of switching criteria 124 for various policies are described below with reference to FIG. 3. Generally, however, the switching criteria 124 are defined such that the system 100 implements an “intra-episode” switching scheme in which the system 100 switches between control policies 124 during a task episode, e.g., instead of only in between task episodes, and in which each control policy 124 can be used to control the agent for multiple consecutive time steps during the episode. As will be described in more detail below with reference to FIGS. 2-6, employing intra-episode switching can significantly improve the quality of the training data generated by the system 100.

Controlling the agent 104 using the policy data 120 to perform a task episode will be described in more detail below with reference to FIGS. 3-5.

In some implementations, the environment is a real-world environment, the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example from a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example the simulated environment may be a simulation of a robot or vehicle and the reinforcement learning system may be trained on the simulation and then, once trained, used in the real-world.

In some implementations the environment is a real-world manufacturing environment for manufacturing a product, such as a chemical, biological, or mechanical product, or a food product. As used herein a “manufacturing” a product also includes refining a starting material to create a product, or treating a starting material e.g. to remove pollutants, to generate a cleaned or recycled product. The manufacturing plant may comprise a plurality of manufacturing units such as vessels for chemical or biological substances, or machines, e.g. robots, for processing solid or other materials. The manufacturing units are configured such that an intermediate version or component of the product is moveable between the manufacturing units during manufacture of the product, e.g. via pipes or mechanical conveyance. As used herein manufacture of a product also includes manufacture of a food product by a kitchen robot.

The agent may comprise an electronic agent configured to control a manufacturing unit, or a machine such as a robot, that operates to manufacture the product. That is, the agent may comprise a control system configured to control the manufacture of the chemical, biological, or mechanical product. For example the control system may be configured to control one or more of the manufacturing units or machines or to control movement of an intermediate version or component of the product between the manufacturing units or machines.

As one example, a task performed by the agent may comprise a task to manufacture the product or an intermediate version or component thereof. As another example, a task performed by the agent may comprise a task to control, e.g. minimize, use of a resource such as a task to control electrical power consumption, or water consumption, or the consumption of any material or consumable used in the manufacturing process.

The actions may comprise control actions to control the use of a machine or a manufacturing unit for processing a solid or liquid material to manufacture the product, or an intermediate or component thereof, or to control movement of an intermediate version or component of the product within the manufacturing environment e.g. between the manufacturing units or machines. In general the actions may be any actions that have an effect on the observed state of the environment, e.g. actions configured to adjust any of the sensed parameters described below. These may include actions to adjust the physical or chemical conditions of a manufacturing unit, or actions to control the movement of mechanical parts of a machine or joints of a robot. The actions may include actions imposing operating conditions on a manufacturing unit or machine, or actions that result in changes to settings to adjust, control, or switch on or off the operation of a manufacturing unit or machine.

The rewards or return may relate to a metric of performance of the task. For example in the case of a task that is to manufacture a product the metric may comprise a metric of a quantity of the product that is manufactured, a quality of the product, a speed of production of the product, or to a physical cost of performing the manufacturing task, e.g. a metric of a quantity of energy, materials, or other resources, used to perform the task. In the case of a task that is to control use a resource the matric may comprise any metric of usage of the resource.

In general observations of a state of the environment may comprise any electronic signals representing the functioning of electronic and/or mechanical items of equipment. For example a representation of the state of the environment may be derived from observations made by sensors sensing a state of the manufacturing environment, e.g. sensors sensing a state or configuration of the manufacturing units or machines, or sensors sensing movement of material between the manufacturing units or machines. As some examples such sensors may be configured to sense mechanical movement or force, pressure, temperature; electrical conditions such as current, voltage, frequency, impedance; quantity, level, flow/movement rate or flow/movement path of one or more materials; physical or chemical conditions e.g. a physical state, shape or configuration or a chemical state such as pH; configurations of the units or machines such as the mechanical configuration of a unit or machine, or valve configurations; image or video sensors to capture image or video observations of the manufacturing units or of the machines or movement; or any other appropriate type of sensor. In the case of a machine such as a robot the observations from the sensors may include observations of position, linear or angular velocity, force, torque or acceleration, or pose of one or more parts of the machine, e.g. data characterizing the current state of the machine or robot or of an item held or processed by the machine or robot. The observations may also include, for example, sensed electronic signals such as motor current or a temperature signal, or image or video data for example from a camera or a LIDAR sensor. Sensors such as these may be part of or located separately from the agent in the environment.

In some implementations the environment is the real-world environment of a service facility comprising a plurality of items of electronic equipment, such as a server farm or data center, for example a telecommunications data center, or a computer data center for storing or processing data, or any service facility. The service facility may also include ancillary control equipment that controls an operating environment of the items of equipment, for example environmental control equipment such as temperature control e.g. cooling equipment, or air flow control or air conditioning equipment. The task may comprise a task to control, e.g. minimize, use of a resource, such as a task to control electrical power consumption, or water consumption. The agent may comprise an electronic agent configured to control operation of the items of equipment, or to control operation of the ancillary, e.g. environmental, control equipment.

In general the actions may be any actions that have an effect on the observed state of the environment, e.g. actions configured to adjust any of the sensed parameters described below. These may include actions to control, or to impose operating conditions on, the items of equipment or the ancillary control equipment, e.g. actions that result in changes to settings to adjust, control, or switch on or off the operation of an item of equipment or an item of ancillary control equipment.

In general observations of a state of the environment may comprise any electronic signals representing the functioning of the facility or of equipment in the facility. For example a representation of the state of the environment may be derived from observations made by any sensors sensing a state of a physical environment of the facility or observations made by any sensors sensing a state of one or more of items of equipment or one or more items of ancillary control equipment. These include sensors configured to sense electrical conditions such as current, voltage, power or energy; a temperature of the facility; fluid flow, temperature or pressure within the facility or within a cooling system of the facility; or a physical facility configuration such as whether or not a vent is open.

The rewards or return may relate to a metric of performance of the task. For example in the case of a task to control, e.g. minimize, use of a resource, such as a task to control use of electrical power or water, the metric may comprise any metric of use of the resource.

In some implementations the environment is the real-world environment of a power generation facility e.g. a renewable power generation facility such as a solar farm or wind farm. The task may comprise a control task to control power generated by the facility, e.g. to control the delivery of electrical power to a power distribution grid, e.g. to meet demand or to reduce the risk of a mismatch between elements of the grid, or to maximize power generated by the facility. The agent may comprise an electronic agent configured to control the generation of electrical power by the facility or the coupling of generated electrical power into the grid. The actions may comprise actions to control an electrical or mechanical configuration of an electrical power generator such as the electrical or mechanical configuration of one or more renewable power generating elements e.g. to control a configuration of a wind turbine or of a solar panel or panels or mirror, or the electrical or mechanical configuration of a rotating electrical power generation machine. Mechanical control actions may, for example, comprise actions that control the conversion of an energy input to an electrical energy output, e.g. an efficiency of the conversion or a degree of coupling of the energy input to the electrical energy output. Electrical control actions may, for example, comprise actions that control one or more of a voltage, current, frequency or phase of electrical power generated.

The rewards or return may relate to a metric of performance of the task. For example in the case of a task to control the delivery of electrical power to the power distribution grid the metric may relate to a measure of power transferred, or to a measure of an electrical mismatch between the power generation facility and the grid such as a voltage, current, frequency or phase mismatch, or to a measure of electrical power or energy loss in the power generation facility. In the case of a task to maximize the delivery of electrical power to the power distribution grid the metric may relate to a measure of electrical power or energy transferred to the grid, or to a measure of electrical power or energy loss in the power generation facility.

In general observations of a state of the environment may comprise any electronic signals representing the electrical or mechanical functioning of power generation equipment in the power generation facility. For example a representation of the state of the environment may be derived from observations made by any sensors sensing a physical or electrical state of equipment in the power generation facility that is generating electrical power, or the physical environment of such equipment, or a condition of ancillary equipment supporting power generation equipment. Such sensors may include sensors configured to sense electrical conditions of the equipment such as current, voltage, power or energy; temperature or cooling of the physical environment; fluid flow; or a physical configuration of the equipment; and observations of an electrical condition of the grid e.g. from local or remote sensors. Observations of a state of the environment may also comprise one or more predictions regarding future conditions of operation of the power generation equipment such as predictions of future wind levels or solar irradiance or predictions of a future electrical condition of the grid.

As another example, the environment may be a chemical synthesis or protein folding environment such that each state is a respective state of a protein chain or of one or more intermediates or precursor chemicals and the agent is a computer system for determining how to fold the protein chain or synthesize the chemical. In this example, the actions are possible folding actions for folding the protein chain or actions for assembling precursor chemicals/intermediates and the result to be achieved may include, e.g., folding the protein so that the protein is stable and so that it achieves a particular biological function or providing a valid synthetic route for the chemical. As another example, the agent may be a mechanical agent that performs or controls the protein folding actions or chemical synthesis steps selected by the system automatically without human interaction. The observations may comprise direct or indirect observations of a state of the protein or chemical/intermediates/precursors and/or may be derived from simulation.

In a similar way the environment may be a drug design environment such that each state is a respective state of a potential pharmachemical drug and the agent is a computer system for determining elements of the pharmachemical drug and/or a synthetic pathway for the pharmachemical drug. The drug/synthesis may be designed based on a reward derived from a target for the drug, for example in simulation. As another example, the agent may be a mechanical agent that performs or controls synthesis of the drug.

In some further applications, the environment is a real-world environment and the agent manages distribution of tasks across computing resources e.g. on a mobile device and/or in a data center. In these implementations, the actions may include assigning tasks to particular computing resources.

As further example, the actions may include presenting advertisements, the observations may include advertisement impressions or a click-through count or rate, and the reward may characterize previous selections of items or content taken by one or more users.

In some cases, the observations may include textual or spoken instructions provided to the agent by a third-party (e.g., an operator of the agent). For example, the agent may be an autonomous vehicle, and a user of the autonomous vehicle may provide textual or spoken instructions to the agent (e.g., to navigate to a particular location).

As another example the environment may be an electrical, mechanical or electro-mechanical design environment, e.g. an environment in which the design of an electrical, mechanical or electro-mechanical entity is simulated. The simulated environment may be a simulation of a real-world environment in which the entity is intended to work. The task may be to design the entity. The observations may comprise observations that characterize the entity, e.g. observations of a mechanical shape or of an electrical, mechanical, or electro-mechanical configuration of the entity, or observations of parameters or properties of the entity. The actions may comprise actions that modify the entity e.g. that modify one or more of the observations. The rewards or return may comprise one or more metric of performance of the design of the entity. For example rewards or return may relate to one or more physical characteristics of the entity such as weight or strength or to one or more electrical characteristics of the entity such as a measure of efficiency at performing a particular function for which the entity is designed. The design process may include outputting the design for manufacture, e.g. in the form of computer executable instructions for manufacturing the entity. The process may include making the entity according to the design. Thus a design an entity may be optimized, e.g. by reinforcement learning, and then the optimized design output for manufacturing the entity, e.g. as computer executable instructions; an entity with the optimized design may then be manufactured.

As previously described the environment may be a simulated environment. Generally in the case of a simulated environment the observations may include simulated versions of one or more of the previously described observations or types of observations and the actions may include simulated versions of one or more of the previously described actions or types of actions. For example the simulated environment may be a motion simulation environment, e.g., a driving simulation or a flight simulation, and the agent may be a simulated vehicle navigating through the motion simulation. In these implementations, the actions may be control inputs to control the simulated user or simulated vehicle. Generally the agent may be implemented as one or more computers interacting with the simulated environment.

The simulated environment may be a simulation of a particular real-world environment and agent. For example, the system may be used to select actions in the simulated environment during training or evaluation of the system and, after training, or evaluation, or both, are complete, may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

Optionally, in any of the above implementations, the observation at any given time step may include data from a previous time step that may be beneficial in characterizing the environment, e.g., the action performed at the previous time step, the reward received at the previous time step, or both.

FIG. 2 is a diagram showing examples of switching schemes that switch between control policies.

In the example of FIG. 2, there are two control policies: an exploration control policy that selects actions to cause the agent to attempt to explore the environment and an exploitation control policy that selects actions to cause the agent to attempt to successfully perform the task in the environment during the task episode, e.g., without regard for exploring the environment. Operating under the control of the exploration control policy is referred to in FIG. 2 as “explore mode” and operating under the control of the exploration control policy is referred to in FIG. 2 as “exploit mode.”

More specifically, FIG. 2 includes a chart 200 of how seven types of switching schemes A-G are applied during an experiment that includes performing multiple task episodes. The chart 200 illustrates “episode boundaries” that delineate different episodes during the experiment, e.g., that occur after time steps at which one episode terminates and before the first time step of the next episode.

Switching scheme type A has experiment-level granularity, where the same control policy (in this case, the exploration control policy) is used to control the agent for an entire experiment, e.g., for all of the episodes in the experiment.

Switching scheme type B has episode-level granularity, where the control policy is switched after each episode ends. In the example of FIG. 2, control policy type B switches between explore mode and exploit mode at the beginning of every episode.

Switching scheme type C has step-level granularity, where the decision to explore is taken independently at each time step, affecting one action. For example the control policy type C can be implemented as an ϵ-greedy exploration policy in which the system 100 selects the action with the highest final return estimate with probability 1−ε and selects a random action from the set of actions with probability ε.

Switching scheme types D-G are intra-episode switching schemes that have intra-episodic granularity that falls in-between step- and episode-level exploration. That is, for switching schemes that have intra-episodic granularity, exploration periods last for multiple time steps, but less than a full episode. As can be seen from FIG. 2, each of the schemes D-G results in the agent operating in explore mode for multiple consecutive time steps at multiple different points within any given episode.

FIG. 2 also shows a plot 250 that plots, for each of the switching scheme types A-G, p_{X} for the switching scheme and med_{X} for the switching scheme. med_{X} is the median length (in number of time steps) of an exploratory period, where an exploratory period is a consecutive set of time steps during which the agent is controlled using the exploration policy. p_{X} is the proportion of time steps during the experiment at which the agent is controlled using the exploration policy. As can be seen from the plot, switching scheme types D-G that employ intra-episodic granularity have med_{X} values that are less than the length of an episode but are significantly higher than one time step. In particular, C, D, E, F share the same p_{X}, while interleaving exploration modes in different ways. D and E share the same med_{X} value, and differ only on whether exploration periods are spread out, or happen toward the end of a task episode.

FIG. 3 is a flow diagram of an example process 300 for performing a task episode. For convenience, the process 300 will be described as being performed by a system of one or more computers located in one or more locations. For example, an action selection system, e.g., the action selection system 100 of FIG. 1, appropriately programmed in accordance with this specification, can perform the process 300.

As described above, the system maintains control policy data that specifies: (i) a plurality of control policies for controlling the agent and (ii) for each of the control policies, a respective switching criterion that governs switching, during a task episode, from controlling the agent using the control policy to controlling the agent using another control policy from the plurality of control policies.

The system then performs the process 300 at each time step during the task episode in order to determine which control policy to use to control the agent at the time step and to select an action using the selected control policy. The system continues performing the process 300 until termination criteria for the episode are satisfied, e.g., until the task has been successfully performed, until the environment reaches a designated termination state, or until a maximum number of time steps have elapsed during the episode.

The system receives a current observation characterizing a state of the environment at the time step (step 302).

For each time step after the first time step in the task episode, the system then performs steps 304-308.

The system identifies a control policy that was used to select the action that was performed by the agent at a preceding time step (step 304). That is, the system checks which control policy was used to control the agent at the preceding time step, e.g., the time step immediately before the current time step.

The system determines whether the respective switching criterion for the identified control policy is satisfied at the current time step (step 306).

As described above, the system can employ any of a variety of different switching criteria and different control policies can have different switching criteria.

For example, one or more of the control policies can have a “blind” switching criterion. A blind switching criterion is one that does not take any state into account, e.g., not the state of the environment or the state of the outputs generated by any of the control policies, and is only concerned with producing switches between policies at some desired time resolution.

One example of a blind switching criterion is one that specifies that the agent switches from being controlled by the control policy after the agent has been controlled by the control policy for a threshold number of time steps during the task episode.

The system can determine the threshold number of time steps in any of a variety of ways.

As one example, the threshold number of time steps can be provided as input to the system and can be constant across all episodes.

As another example, the system can sample from a fixed probability distribution over a set of possible thresholds at the outset of any given episode and use the sampled threshold value for all of the time steps in the task episode.

As another example, the system can select the threshold number of time steps from a set of possible threshold numbers using a non-stationary multi-armed bandit that maximises episodic return and use the selected threshold value for all of the time steps in the task episode. As described above, the episodic return can be an undiscounted sum or a time-discounted sum of the rewards received at the time steps in a given task episode. In general a non-stationary multi-armed bandit may be an action selection system that selects one of multiple possible options according to a probability distribution that is non-stationary, e.g. that may change over time. Thus in this example the bandit acts as a meta-controller to adapt the threshold number of time steps.

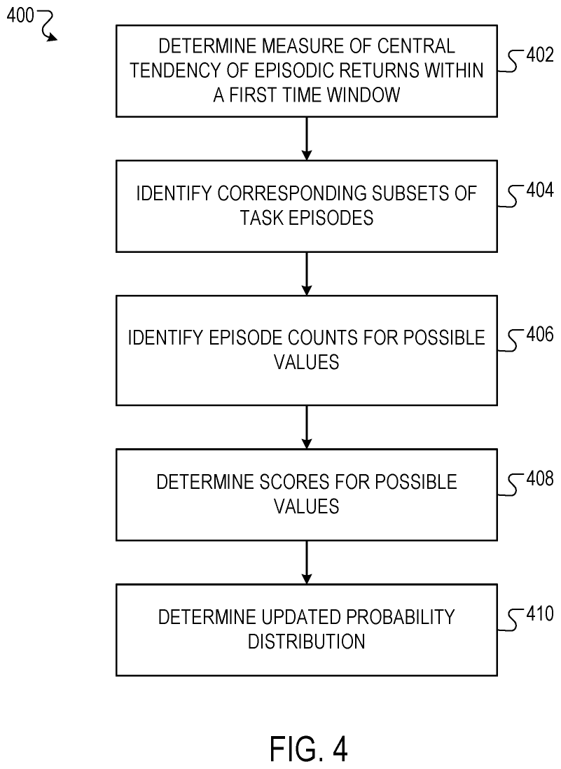

Selecting a value for a “parameter” (in this case, the threshold value) of a criterion from a set of possible parameter values using the bandit is described in more detail below with reference to FIG. 4.

Another example of a blind switching criterion is one that specifies that the agent switches from being controlled by the control policy with a specified probability after each time step at which the control policy is used to control the agent.

The system can determine the specified probability in any of a variety of ways.

As one example, the specified probability can be provided as input to the system and can be constant across all episodes.

As another example, the system can sample from a fixed probability distribution over a set of possible specified probabilities at the outset of any given episode and use the sampled probability value for all of the time steps in the task episode.

As another example, the system can select the specified probability from a set of possible probabilities using a non-stationary multi-armed bandit that maximises episodic return and use the selected probability for all of the time steps in the task episode. Here the bandit acts as a meta-controller to adapt the specified probability. Selecting a value for a “parameter” (in this case, the specified probability) of a criterion from a set of possible parameter values using the bandit is described in more detail below with reference to FIG. 4.

As another example, one or more of the control policies can have an “informed” switching criterion that switches based in part on a current state of the episode, e.g., the current state of the environment or current and/or previous outputs generated by the control policy. In particular, when the switching criterion is an informed switching criterion, the system computes a trigger value for the current time step, in implementations a scalar value, based on a state of the task episode as of the current time step and determines whether the switching criterion is satisfied based on the trigger value for the current time step. For example, if the switching criterion is satisfied the system may switch away from the identified control policy (used to select the action that was performed by the agent at a preceding time step). As described below the switching criterion may be based on a difference-on a difference between a threshold value for the current time step (that may be an adaptive threshold value) and the trigger value for the current time step. The trigger value may represent a degree of uncertainty within the system e.g. of the value of a state of the environment, or of an action to take. That the switching criterion is satisfied based on the trigger value may indicate an increased degree of uncertainty. The system may then select a control policy with an increased degree of exploration of the environment e.g. it may then switch from an exploitation control policy as described above, to an exploration control policy as described above. The identified control policy may be the exploitation control policy and may, for convenience of labelling, be referred to as a “third” control policy (although, as noted above, this does not imply that there are necessarily two other control policies—e.g. there may be only one other control policy).

As a particular example, the system can determine a specified, e.g. particular, threshold value for the current time step and determine whether the respective switching criterion for the third control policy is satisfied based on a difference between the specified threshold value for the current time step and the trigger value for the current time step.

For example, the system can determine that the criterion is satisfied when the trigger value exceeds the switching criterion.

As another example, the system can determine whether the criterion is satisfied based on a value sampled from a probability distribution that is parameterized based on the difference between the specified threshold value for the current time step and the trigger value for the current time step. For example, the distribution can be a Bernoulli distribution. Then, for example, the system can generate a value that represents the probability that the Bernoulli variable takes a value of 1 (and, therefore, that the criterion is satisfied). In this example, the system can compute the probability as the minimum between 1 and the ratio between the difference between (i) the specified threshold value for the current time step and the trigger value for the current time step and (ii) the specified threshold value. Thus, the probability that the variable takes a value of 1 (and, therefore, that the switching criterion is satisfied) is higher the larger the difference.

While directly comparing the trigger value to a threshold value may be effective for certain tasks, for other tasks the scales of the informed trigger signals may vary substantially and across training time. This can make it difficult to select an effective threshold value at the outset of any given task episode, e.g., it is impractical to attempt to manually set the threshold hyper-parameter.

Therefore, in some implementations, instead of directly comparing the trigger value to the threshold value, the system can obtain a target switching rate for the time step. The target switching rate represents a target proportion of time steps at which the switching criterion is satisfied.

The system can then use the trigger value and the target switching rate to determine whether the switching criterion is satisfied using “homeostasis”. Homeostasis tracks recent values of the signal and adapts the threshold for switching so that the target switching rate is obtained. For example, the system can use the trigger value and the target switching rate, e.g. for a sequence of binary switching decisions, to adapt the threshold for switching. In particular, the system can generate a current trigger value for the current time step based on previous trigger values at preceding time steps within the task episode. The current trigger value may be standardized (e.g. subtracted from its mean and then divided by its standard deviation); it may be exponentiated (as usually defined, e.g. a base b, e.g. the number e, is raised to the power of the current trigger value), to turn it into a positive number. The system may then determine whether the switching criterion for the control policy is satisfied based on the target switching rate for the current time step and the standardized and exponentiated current trigger value.

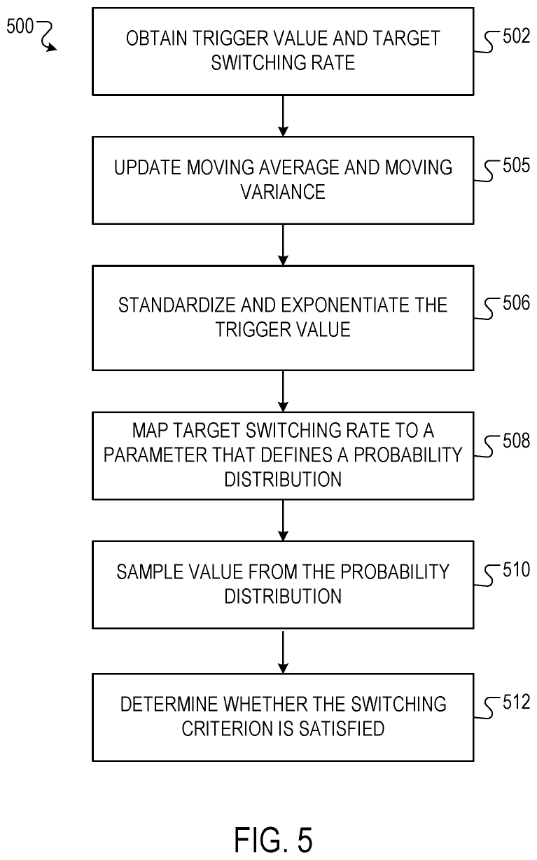

Determining the standardized and exponentiated trigger value and determining whether the switching criterion are satisfied are described below with reference to FIG. 5.

By making use of homeostasis, the system only requires specifying the target switching rate, which can be constant across domains but still function as an adaptive threshold, making tuning straightforward because the target rate of switching is configured independently of the scales of the trigger signal.

The system can determine the target switching rate in any of a variety of ways.

As one example, the target switching rate can be provided as input to the system and can be constant across all episodes.

As another example, the system can sample from a fixed probability distribution over a set of possible target switching rates at the outset of any given episode and use the sampled target switching rate for all of the time steps in the task episode.

As another example, the system can select the target switching rate from a set of possible target switching rates using a non-stationary multi-armed bandit that maximises episodic return and use the selected threshold value for all of the time steps in the task episode. Here the bandit acts as a meta-controller to adapt the target switching rate. Selecting a value for a “parameter” (in this case, the target switching rate) of a criterion from a set of possible parameter values using the bandit is described in more detail below with reference to FIG. 4.

The system can compute the trigger value based on the state of the task episode in any of a variety of ways.

As one example, the trigger value can be an estimate of an uncertainty in reward estimates generated by the control policy over a recent time window as of the current time step. That is, the trigger value can be computed such that when uncertainty in the control policy's (action) predictions are higher, the trigger value is more likely to be satisfied. The recent time window may represent a time scale of interest for the task; it may be a predetermined time window.

As a particular example, as described above, in some implementations, the control policy can generate value estimates in addition to action selection outputs. In some of these implementations, the trigger value measures an accuracy of a value estimate generated at an earlier time step in the recent time window by the control policy, e.g., an estimate of a value of the environment being in an earlier state at the earlier time step, given actual rewards that have been received at time steps after the earlier time step. For example, the trigger value at time step t can satisfy:

$$\vert V ( {s}_{t - k} ) - {\sum }_{i = 0}^{k - 1} {γ}^{i} {R}_{t - i} - {γ}^{k} V ( {s}_{t} ) \vert ,$$

where V(sₜ₋ₖ) is the value estimate at time step t-k, k is a fixed positive integer, γ is a fixed discount factor between zero and one, Rₜ₋ᵢ is the reward received at time step t-i, and V(sₜ) is the value estimate at time step t. Thus, the trigger value measures (an absolute value of) the difference between the value estimate at the earlier time step and the sum of (i) the value estimate at the current time step and (ii) a time-discounted sum of the rewards received at time steps between the earlier time step and the current time step (including the current time step).

In some implementations, the control policy can include an ensemble of neural networks that each generate a respective action selection output and, optionally, a respective value estimate. In some of these implementations, the trigger value is based on outputs of the neural networks in the ensemble generated by processing inputs that include the current observation. That is, the trigger value is computed such that when there is more disagreement between the outputs generated by the neural networks in the ensemble, the criterion is more likely to be satisfied.

As a particular example, the trigger value can measure a discrepancy between (action selection) outputs of the neural networks in the ensemble generated by processing inputs that include the current observation. For example, when the action selection outputs assign a respective score, e.g., a respective probability or a respective Q value, to each action in the set of actions, the system can compute the discrepancy measure by ranking the actions according to each neural network and then computing how large the overlap among the top-k actions from each neural network is, with smaller overlap yielding higher trigger values and larger overlap yielding lower trigger values.

As another particular example, the trigger value can measure the variance between outputs, e.g., action selection outputs, value estimates, or both, of the neural networks in the ensemble generated by processing inputs that include the current observation, with larger variance yielding higher trigger values and smaller variance yielding lower trigger values.

As another particular example, the trigger value for the current time step can be an estimate of a saliency of stimuli observed by the agent as of the current time step, e.g. a relative measure of the novelty of the state of the environment at the current time step as compared with one or more previous time steps. Further description of salience can be found in Jonathan Downar, Adrian P Crawley, David J Mikulis, and Karen D Davis. A cortical network sensitive to stimulus salience in a neutral behavioral context across multiple sensory modalities. Journal of neurophysiology, 87(1):615-620, 2002.

As another particular example, the trigger value for the current time step can be an estimate of a (minimal) coverage, e.g. the number of different states of the environment reached, as of the current time step. An example of computing such an estimate is described in Yuu Jinnai, Jee Won Park, David Abel, and George Konidaris. Discovering options for exploration by minimizing cover time. In International Conference on Machine Learning, pp. 3130-3139. PMLR, 2019a.

Trigger values can also be computed using a variety of other measures that are based on the current state of the task episode. Examples of other measures include amortised value errors, density models, empowerment measures, and so on. An empowerment measure may be defined as a measure of the information-theoretic capacity of an actuation channel of the agent, e.g. the channel capacity in bits of a channel between an input for the observation and an output for selecting the action to be performed by the agent (zero when no control), e.g. determined as described in A. S. Klyubin, D. Polani, and C. L. Nehaniv. Empowerment: A universal agent-centric measure of control. In 2005 IEEE Congress on Evolutionary Computation, volume 1, pages 128-135. IEEE, 2005.

As described above, different control policies can have different switching criteria. As a particular example, each exploration policy can have a respective one of the blind criteria described above (or a different blind criterion) while each exploitation policy can have a respective one of the informed criteria described above (or a different informed criterion).

The system selects a control policy from the plurality of control policies based on whether the respective switching criterion for the identified control policy is satisfied at the current time step (step 308).

That is, if the respective switching criterion for the identified control policy is not satisfied at the current time step, the system continues controlling the agent using the identified control policy and therefore selects the identified control policy.

When there are two total control policies, if the respective switching criterion for the identified control policy is satisfied at the current time step, the system switches to controlling the agent using the other control policy.

When there are more than two total control policies, the system can determine which of the other control policies to select if the switching criterion is satisfied in any of a variety of ways. For example, the system can select another control policy at random. As another example, the control policy data can specify which other control policy to switch to when the switching criterion is satisfied, and the system can select to the other control policy that is specified in the control policy data. As yet another example, the system can select the other control policy that was used least recently (from among the control polices other than the identified control policies) in controlling the agent.

For the first time step in the task episode, the system can determine which control policy to select in any of a variety of ways.

As one example, the system can determine to always select the same control policy for the first time step of every task episode, e.g., to always select the exploration control policy or to always select the exploitation control policy.

As another example, the system can sample a control policy from a probability distribution over the control policies.

The system selects an action to be performed by the agent in response to the current observation using the selected control policy (step 310).

The manner in which the system selects the action using the selected control policy is dependent on the structure of the selected control policy.

For example, when the selected control policy makes use of a neural network, the system can process an input that includes the observation of the current state of the environment to generate an action selection output that characterizes an action to be performed by the agent in response to the observation and then select the action using the action selection output as described above.

The system then causes the agent to perform the selected action, e.g., by directly submitting a control input to the agent or by transmitting instructions or other data to a control system for the agent that will cause the agent to perform the selected agent.

FIG. 4 is a flow diagram of an example process 400 for selecting a parameter value from a set of parameter values using a non-stationary multi-armed bandit. For convenience, the process 400 will be described as being performed by a system of one or more computers located in one or more locations. For example, an action selection system, e.g., the action selection system 100 of FIG. 1, appropriately programmed, can perform the process 400.

Generally, the action selection system 400 can perform the process 400 to update a probability distribution over the possible parameter values and can then select a value using the probability distribution, e.g., by sampling a value from the probability distribution.

In implementations where values for multiple different parameters are determined using a bandit, the system can performs the process 400 independently for each parameter.

The system determines a measure of central tendency, e.g., a mean, of episodic returns for task episodes within a first specified window (step 402). For example, the system can compute the measure of central tendency of measures of fitness for the h most recent episodes, where h is an integer greater than 1.

The system identifies, for each particular possible value of the given parameter, a corresponding subset of episodes in a second specified window that were performed while the particular value of the given parameter was selected (step 404). In some cases, the first specified window can be the same as the second specified window. In some other cases, however, the first and second windows are different, e.g., the second window can be longer than the first window.

The system identifies, for each particular possible value of the given parameter, a count of episodes in the corresponding subset that had an episodic return that was greater than or equal to the measure of central tendency (step 406).

The system determines, for each particular possible value of the given parameter, a score from the count of episodes and the total number of task episodes in the corresponding subset (step 408).

Generally, the score is an estimate of the likelihood that a task episode for which the possible value of the given modulation factor was selected will have a episodic return that is greater than or equal to the measure of central tendency. For example, the system can set the score equal to (i) ½ plus the count of episodes divided by (ii) 1 plus the total number of task episodes in the subset.

The system determines an updated probability distribution from the respective scores for the possible values of the given parameter (step 410). In particular, the system normalizes the respective scores into probabilities, e.g., normalizes the scores so that the scores add to 1.

In some implementations, the system adjusts the first window, the second window, or both as task episodes are performed. For example, the system can set both windows equal to the same value and adjust the value using a regression accuracy criterion. In particular, in this example the system can repeatedly adapt the value to identify the window size that minimizes a loss that measures regression accuracy. For example, the loss can measure the squared error between (i) a episodic reward of a value chosen at a given time t and (ii) a quantity that represents a prediction of the episodic reward for the value chosen at time t given the episodic returns that have been received during the current time window.

FIG. 5 is a flow diagram of an example process 500 for determining whether a switching criterion is satisfied at the current time step using a target switching rate. For convenience, the process 500 will be described as being performed by a system of one or more computers located in one or more locations. For example, an action selection system, e.g., the action selection system 100 of FIG. 1, appropriately programmed, can perform the process 500.

The system obtains a trigger value for the current time step and the target switching rate for the current time step (step 502) as described above.

The system then generates a standardized and exponentiated current trigger value for the current time step based on previous trigger values at preceding time steps within the task episode.

In implementations to generate the standardized and exponentiated current trigger value, the system updates, using the current trigger value, a moving average of the trigger values computed from the previous trigger values and a moving variance of the trigger values computed from the previous trigger values (step 504).

The system standardizes the current trigger value using the updated moving average and the updated moving variance and then exponentiates the standardized current trigger value to generate the standardized and exponentiated current trigger value (step 506).

The system then determines whether the respective switching criterion for the third control policy is satisfied based on the target switching rate for the current time step and the standardized and exponentiated current trigger value.

In particular, the system maps the target switching rate for the current time step and the standardized and exponentiated current trigger value to a parameter that defines a probability distribution (step 508).

For example, the distribution can be a Bernoulli distribution and the system can generate a value that represents the probability that the Bernoulli variable takes a value of 1. In this example, the system can update, using the standardized and exponentiated current trigger value, a moving average of the standardized and exponentiated trigger values computed from the standardized and exponentiated versions of the previous trigger values. The system can then compute the probability as the minimum between 1 and the product of the target switching rate and the ratio between the standardized and exponentiated current trigger value and the updated moving average of the standardized and exponentiated trigger values. Thus, the probability that the variable takes a value of 1 (and, therefore, that the switching criterion is satisfied) is higher the larger the current trigger value and the larger the ratio between the standardized and exponentiated current trigger value and the updated moving average of the standardized and exponentiated trigger values.

The system then samples a value from the probability distribution (step 510) and determines whether the respective switching criterion for the control policy is satisfied based on the sampled value (step 512). For example, when the distribution is a Bernoulli distribution, the system can determine that the switching criterion is satisfied when the sampled value is a 1 and that the switching criterion is not satisfied when the sampled value is a 0.

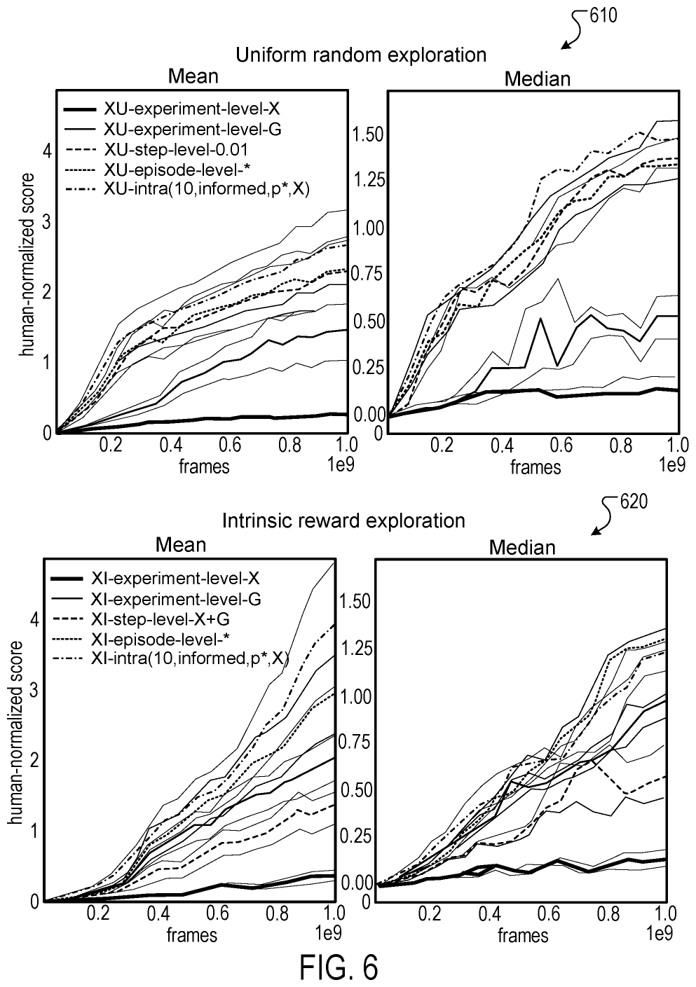

FIG. 6 shows the performance of various intra-episode switching schemes relative to other control schemes. More specifically, in FIG. 6, the performance shown is aggregated across seven tasks that require the agent to repeatedly process image frames in order to select actions and across three seeds for each task. The performance is “human-normalized,” e.g., so that the performance on a given task is measured relative to the performance of a human-controlled agent on that task, and is shown relative to the number of frames that have been collected as of a certain point in the training.

In particular, a first plot 610 shows various switching schemes that use a uniform random exploration policy and a learned exploitation policy, while a second plot 620 shows various switching schemes that use an intrinsic reward exploration policy (e.g., a RND-based exploration policy) and a learned exploitation policy.

In particular, the first and second plots 610 and 620 show the performance of two experiment level switching schemes: one that explores for the entire experiment (XU-experiment-level-X) and another that exploits the entire experiment (XU-experiment-level-G). The first and second plots 610 and 620 also show the performance of a step-level switching scheme (XU-step-level-0.01) that uses ε-greedy with an ε of 0.01 and an episodic switching scheme that can switch at the completion of each episode (XU-episode-level-*).

Finally, the first and second plots 610 and 620 show the performance of an intra-episode scheme that uses a blind trigger for the exploration policy and an informed trigger for the exploitation policy (XU-intra(10,informed,p*,X).

As can be seen from the plots 610 and 620, the intra-episodic schemes are on par with or better than the other schemes with both exploration policies. That is, intra-episodic switching as described in this specification results in a learned policy that is on part with or better than existing switching schemes across a range of different tasks and across different amounts of collected training data.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System(GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

1. A method performed by one or more computers, the method comprising:
maintaining control policy data for controlling an agent to interact with an environment, the control policy data specifying:
(i) a plurality of control policies for controlling the agent,
(ii) for each of the control policies, a respective switching criterion that governs switching, during a task episode, from controlling the agent using the control policy to controlling the agent using another control policy from the plurality of control policies; and
controlling the agent to perform a task episode in the environment, wherein, during the task episode, the agent performs a respective action at each of a plurality of time steps that is selected using a respective one of the plurality of control policies, and wherein controlling the agent to perform the task episode comprises, at each of the plurality of time steps:
receiving a current observation characterizing a state of the environment at the time step;
identifying a control policy that was used to select the action that was performed by the agent at a preceding time step;
determining whether the respective switching criterion for the identified control policy is satisfied at the current time step;
selecting a control policy from the plurality of control policies based on whether the respective switching criterion for the identified control policy is satisfied at the current time step;
selecting an action to be performed by the agent in response to the current observation using the selected control policy; and
causing the agent to perform the selected action.

2. The method of claim 1, wherein the plurality of control policies comprise:
an exploration control policy that selects actions to cause the agent to attempt to explore the environment; and
an exploitation control policy that selects actions to cause the agent to attempt to successfully perform a task in the environment during the task episode.

3. The method of claim 2, wherein the exploration control policy is a random control policy that selects an action from a set of possible actions uniformly at random.

4. The method of claim 2, wherein the exploration control policy selects an action from a set of possible actions that optimizes a novelty measure as estimated by the exploration control policy.

5. The method of claim 2, wherein the exploitation control policy is learned through reinforcement learning and selects actions that cause the agent to maximize an expected future return as estimated by the exploitation control policy.

6. The method of claim 1, further comprising:
generating, from at least the observations received at the plurality of time steps and the actions performed at the plurality of time steps, training data; and
updating one or more of the control policies using the training data.

7. The method of claim 1, wherein, for a first control policy of the plurality of control policies, the respective switching criterion specifies that the agent switches from being controlled by the first control policy after the agent has been controlled by the control policy for a threshold number of time steps during the task episode.

8. The method of claim 7, wherein the threshold number is selected from a set of possible threshold numbers using a non-stationary multi-armed bandit that maximises episodic return.

9. The method of claim 1, wherein, for a second control policy of the plurality of control policies, the respective switching criterion specifies that the agent switches from being controlled by the second control policy with a specified probability after each time step at which the second control policy is used to control the agent.

10. The method of claim 9, wherein the specified probability is selected from a set of possible probabilities using a non-stationary multi-armed bandit that maximises episodic return.

11. The method of claim 1, wherein, for a third control policy of the plurality of control policies, the respective switching criterion specifies that the agent switches from being controlled by the third control policy at a given time step based on a trigger value for the given time step.

12. The method of claim 11, wherein, when the identified control policy is the third control policy, determining whether the respective switching criterion for the identified control policy is satisfied at the current time step comprises:
computing a trigger value for the current time step based on a state of the task episode as of the current time step; and
determining whether the respective switching criterion for the third control policy is satisfied based on the trigger value for the current time step.

13. The method of claim 11, wherein the trigger value for the current time step is an estimate of an uncertainty in reward estimates generated by the third control policy over a recent time window as of the current time step.

14. The method of claim 13, wherein the trigger value measures an accuracy of an estimate, generated by the third control policy, of a value of the environment being in an earlier state at an earlier time step in the recent time window given actual rewards that have been received at time steps after the earlier time step.

15. The method of claim 13, wherein the third control policy comprises an ensemble of neural networks, and wherein the trigger value measures a discrepancy between outputs of the neural networks in the ensemble generated by processing inputs comprising the current observation.

16. The method of claim 13, wherein the third control policy comprises an ensemble of neural networks, and wherein the trigger value measures a variance between outputs of the neural networks in the ensemble generated by processing inputs comprising the current observation.

17. The method of claim 12, wherein the trigger value for the current time step is an estimate of a saliency of stimuli observed by the agent as of the current time step.

18. The method of claim 12, wherein the trigger value for the current time step is an estimate of a minimal coverage as of the current time step.

19. The method of claim 12, wherein the trigger value for the current time step is an estimate of information-theoretic capacity of an actuation channel of the agent as of the current time step.

20. The method of claim 11, further comprising:
determining a specified threshold value for the current time step; and
determining whether the respective switching criterion for the third control policy is satisfied based on a difference between the specified threshold value for the current time step and the trigger value for the current time step.

21. The method of claim 20, wherein the specified threshold value is a same predetermined value for each of the time steps in the task episode, and wherein determining whether the respective switching criterion for the third control policy is satisfied based on a difference between the specified threshold value for the current time step comprises:
determining that the criterion is satisfied when the trigger value exceeds the switching criterion; or
determining whether the criterion is satisfied based on a value sampled from a probability distribution parameterized based on the difference between the specified threshold value for the current time step and the trigger value for the current time step.

22. The method of claim 11, wherein determining whether the respective switching criterion for the third control policy is satisfied comprises:
obtaining a target switching rate for the current time step;
generating a standardized and exponentiated current trigger value for the current time step based on previous trigger values at preceding time steps within the task episode; and
determining whether the respective switching criterion for the third control policy is satisfied based on the target switching rate for the current time step and the standardized and exponentiated current trigger value.

23. The method of claim 22, wherein determining whether the respective switching criterion for the third control policy is satisfied based on the target switching rate for the current time step and the standardized and exponentiated current trigger value comprises:
mapping the target switching rate for the current time step and the standardized and exponentiated current trigger value to a parameter that defines a probability distribution;
sampling a value from the probability distribution; and
determining whether the respective switching criterion for the third control policy is satisfied based on the sampled value.

24. The method of claim 22, wherein the target switching rate is a same predetermined value for each of the time steps in the task episode.

25. The method of claim 22, wherein obtaining the target switching rate comprises:
selecting the target switching rate from a set of possible target switching rates using a non-stationary multi-armed bandit that maximises episodic return.

26. The method of claim 1 wherein the agent interacts with the environment to perform a task, and wherein at least one of the control policies is a control policy that uses outputs generated by a neural network, the method further comprising using the neural network to process an input that includes the current observation to generate an action selection output for selecting the action to be performed by the agent in response to the current observation.

27. The method of claim 26 wherein the neural network is used in controlling the agent in a real-world environment, and is configured to process an observation relating to a state of the real-world environment to generate an action selection output that relates to an action to be performed by the agent in the real-world environment; and wherein the agent is either i) a mechanical agent used in the real-world environment to perform a task, or ii) an electronic agent configured to control a manufacturing unit in a real-world manufacturing environment, or iii) an electronic agent configured to control operation of items of equipment in the real-world environment of a service facility comprising a plurality of items of electronic equipment, or iv) an electronic agent used in the real-world environment of a power generation facility and configured to control the generation of electrical power by the facility or the coupling of generated electrical power into the grid.

28. A system comprising:
one or more computers; and
one or more storage devices communicatively coupled to the one or more computers, wherein the one or more storage devices store instructions that, when executed by the one or more computers, cause the one or more computers to perform operations comprising:
maintaining control policy data for controlling an agent to interact with an environment, the control policy data specifying:
(i) a plurality of control policies for controlling the agent,
(ii) for each of the control policies, a respective switching criterion that governs switching, during a task episode, from controlling the agent using the control policy to controlling the agent using another control policy from the plurality of control policies; and
controlling the agent to perform a task episode in the environment, wherein, during the task episode, the agent performs a respective action at each of a plurality of time steps that is selected using a respective one of the plurality of control policies, and wherein controlling the agent to perform the task episode comprises, at each of the plurality of time steps:
receiving a current observation characterizing a state of the environment at the time step;
identifying a control policy that was used to select the action that was performed by the agent at a preceding time step;
determining whether the respective switching criterion for the identified control policy is satisfied at the current time step;
selecting a control policy from the plurality of control policies based on whether the respective switching criterion for the identified control policy is satisfied at the current time step;
selecting an action to be performed by the agent in response to the current observation using the selected control policy; and
causing the agent to perform the selected action.

29. One or more non-transitory computer storage media storing instructions that when executed by one or more computers cause the one or more computers to perform operations comprising:
maintaining control policy data for controlling an agent to interact with an environment, the control policy data specifying:
(i) a plurality of control policies for controlling the agent,
(ii) for each of the control policies, a respective switching criterion that governs switching, during a task episode, from controlling the agent using the control policy to controlling the agent using another control policy from the plurality of control policies; and
controlling the agent to perform a task episode in the environment, wherein, during the task episode, the agent performs a respective action at each of a plurality of time steps that is selected using a respective one of the plurality of control policies, and wherein controlling the agent to perform the task episode comprises, at each of the plurality of time steps:
receiving a current observation characterizing a state of the environment at the time step;
identifying a control policy that was used to select the action that was performed by the agent at a preceding time step;
determining whether the respective switching criterion for the identified control policy is satisfied at the current time step;
selecting a control policy from the plurality of control policies based on whether the respective switching criterion for the identified control policy is satisfied at the current time step;
selecting an action to be performed by the agent in response to the current observation using the selected control policy; and
causing the agent to perform the selected action.
